(19) United States
(12) Patent Application Publication
(10) Pub. No.: US 2022/0111583 A1
(43) Pub. Date: Apr. 14, 2022

(54) METHOD FOR MANUFACTURING THREE-DIMENSIONAL STRUCTURE, AND THREE-DIMENSIONAL STRUCTURE

(71) Applicant: SONY GROUP CORPORATION, TOKYO (JP)

(72) Inventor: SHUNICHI SUWA, TOKYO (US)

(21) Appl. No.: 17/310,662

(22) PCT Filed: Jan. 30, 2020
(86) PCT No.: PCT/JP2020/003426

§ 371 Date: Aug. 16, 2021

(30) Foreign Application Priority Data
Feb. 26, 2019 (JP) 2019-033130

(51) Int. Cl. B29C 64/135; B33Y 10/00; B33Y 40/10; C08F 2/50; B29C 64/321; B29C 64/277; B33Y 30/00

(52) U.S. Cl. CPC B29C 64/135; B33Y 10/00; B33Y 40/10; B33Y 30/00; B29C 64/321; B29C 64/277; C08F 2/50

(57) ABSTRACT

To provide a method for manufacturing a three-dimensional structure, the method being able to freely control physical properties of a three-dimensional structure. Provided is a method for manufacturing a three-dimensional structure, the method including orienting molecules of a first anisotropic material and/or molecules of a second anisotropic material while forming a layer containing the first anisotropic material and/or the second anisotropic material, in which the molecules of the first anisotropic material and/or the molecules of the second anisotropic material are repeatedly oriented a plurality of times while the layer is formed.

### TECHNICAL FIELD

The present technology relates to a method for manufacturing a three-dimensional structure, and more particularly to a method for manufacturing a three-dimensional structure, and a three-dimensional structure.

### BACKGROUND ART

In recent years, various materials have been proposed and commercialized for a 3D printer. Generally, an organic material (polymer resin) is used, but an inorganic material (glass) and a metal material have also been proposed.

For example, a method for manufacturing a three-dimensional structure has been proposed in which a three-dimensional structure is manufactured using a plurality of types of resin materials (see Patent Document 1).

Furthermore, for example, a method for manufacturing a three-dimensional structure has been proposed in which a three-dimensional structure is manufactured using an oriented material (see Patent Document 2).

### CITATION LIST

### Patent Document

Patent Document 1: Japanese Patent Application Laid-Open No. 2017-25187
Patent Document 2: Japanese Patent Application Laid-Open No. 2016-117273

### SUMMARY OF THE INVENTION

### Problems to be Solved by the Invention

However, with the techniques proposed in Patent Documents 1 and 2, there may be a possibility that the physical properties of a three-dimensional structure cannot be freely controlled.

Therefore, the present technology has been achieved in view of such circumstances, and a main object of the present technology is to provide a method for manufacturing a three-dimensional structure, the method being able to freely control physical properties of a three-dimensional structure, and a three-dimensional structure whose physical properties are freely controlled.

### Solutions to Problems

The present inventor made intensive studies in order to solve the above-described object, and as a result, has succeeded in freely controlling physical properties of a three-dimensional structure, and has completed the present technology.

That is, the present technology provides a method for manufacturing a three-dimensional structure, the method including orienting molecules of a first anisotropic material and/or molecules of a second anisotropic material while forming a layer containing the first anisotropic material and/or the second anisotropic material, in which the molecules of the first anisotropic material and/or the molecules of the second anisotropic material are repeatedly oriented a plurality of times while the layer is formed.

In the method for manufacturing a three-dimensional structure according to the present technology, the first anisotropic material may be curable, the first anisotropic material may be an oriented particle material, and the oriented particle material of the first anisotropic material may have an aspect ratio (average major axis length/average minor axis length) of 1.1 or more.

In the method for manufacturing a three-dimensional structure according to the present technology, the second anisotropic material may be curable, the second anisotropic material may be an oriented particle material, and the oriented particle material of the second anisotropic material may have an aspect ratio (average major axis length/average minor axis length) of 1.1 or more.

The method for manufacturing a three-dimensional structure according to the present technology may include orienting molecules of a first anisotropic material and/or molecules of a second anisotropic material while forming a layer containing the first anisotropic material and/or the second anisotropic material and a photosensitive material, in which the photosensitive material may be curable.

The method for manufacturing a three-dimensional structure according to the present technology may include orienting molecules of a first anisotropic material and/or molecules of a second anisotropic material while forming a layer containing the first anisotropic material and/or the second anisotropic material and at least one resin material, in which the layer may be formed using a photopolymerization initiator.

The method for manufacturing a three-dimensional structure according to the present technology may include orienting molecules of a first anisotropic material and/or molecules of a second anisotropic material while forming a layer containing the first anisotropic material and/or the second anisotropic material, a photosensitive material, and at least one resin material, in which the layer may be formed using a photopolymerization initiator, and the photosensitive material may be curable.

The method for manufacturing a three-dimensional structure according to the present technology may further include curing the layer.

In the method for manufacturing a three-dimensional structure according to the present technology, the layer may be formed by a stereolithography apparatus (SLA) method.

In the method for manufacturing a three-dimensional structure according to the present technology, the layer may be formed by an inkjet method.

In the method for manufacturing a three-dimensional structure according to the present technology, the layer may be formed by a projection method.

The method for manufacturing a three-dimensional structure according to the present technology may further include irradiating different regions in the layer with energy rays having different polarization directions.

Furthermore, the present technology provides a three-dimensional structure obtained by the method for manufacturing a three-dimensional structure according to the present technology, particularly obtained by the method for manufacturing a three-dimensional structure according to the present technology, the method further including irradiating different regions in the layer with energy rays having different polarization directions, and having a molecular orientation distribution in at least one of the layers.

Moreover, the present technology provides a three-dimensional structure obtained by the method for manufacturing a three-dimensional structure according to the present technology, particularly obtained by the method for manufacturing a three-dimensional structure according to the present technology, the method further including irradiating different regions in the layer with energy rays having different polarization directions, and having an unoriented region in at least one of the layers, in which the three-dimensional structure may include a region having refractive index anisotropy.

Moreover, the present invention further provides a three-dimensional structure obtained by the method for manufacturing a three-dimensional structure according to the present technology and transparent to an electromagnetic wave in any wavelength band.

According to the present technology, the physical properties of a three-dimensional structure can be freely controlled. Note that the effects described here are not necessarily limited, and may be any of the effects described in the present disclosure or may be different therefrom.

### BRIEF DESCRIPTION OF DRAWINGS

FIG. 1 is a diagram for explaining that a layer containing a resin material is formed using a photopolymerization initiator.

FIG. 2 is a diagram for explaining reactions of photosensitive materials (azobenzene and cinnamate).

FIG. 3 is a diagram illustrating an example of a second anisotropic material.

FIG. 4 is a diagram illustrating an example of a first anisotropic material and an example of the second anisotropic material.

FIG. 5 is a diagram illustrating a configuration example of an SLA type 3D printer device using a laser and a galvanometer mirror.

FIG. 6 is a diagram for explaining that a three-dimensional structure is manufactured using the 3D printer device illustrated in FIG. 5.

FIG. 7 is a diagram illustrating a configuration example of an SLA type 3D printer device using MEMS.

FIG. 8 is a diagram illustrating a configuration example of an SLA type 3D printer device using DLP.

FIG. 9 is a diagram illustrating a configuration example of an SLA type 3D printer device using a liquid crystal projector method.

FIG. 10 is a diagram illustrating a configuration example of an SLA type 3D printer device using a liquid crystal projector method.

FIG. 11 is a diagram illustrating a configuration example of an SLA type 3D printer device using a liquid crystal panel method.

FIG. 12 is a diagram illustrating a configuration example of a 3D printer device used in Example 1.

FIG. 13 is a diagram for explaining that a three-dimensional structure is manufactured using the 3D printer device illustrated in FIG. 12 (used in Example 1).

FIG. 14 is a diagram for explaining that a molecular orientation state can be confirmed using a crossed Nicols polarizing plate.

FIG. 15 is a diagram illustrating a reaction (structural change) of azobenzene caused by light irradiation or heat.

FIG. 16 is a diagram illustrating a reaction of cinnamate.

### MODE FOR CARRYING OUT THE INVENTION

Hereinafter, a preferred embodiment for carrying out the present technology will be described. The embodiments described below exemplify representative embodiments of the present technology, and the scope of the present technology is not narrowly interpreted by the embodiments. Note that in the drawings, the same or equivalent elements or members are designated by the same reference numeral, and duplicate description will be omitted.

Furthermore, unless otherwise specified, in the drawings, “upper” means an upper direction or an upper side in the drawings, “lower” means a lower direction or a lower side in the drawings, “left” means a left direction or a left side in the drawings, and “right” means a right direction or a right side in the drawings.

Note that the description will be made in the following order.

1. Summary of the present technology

2. First embodiment (example of method for manufacturing three-dimensional structure)

3. Second embodiment (example of three-dimensional structure)

### 1. Summary of the Present Technology

First, summary of the present technology will be described.

The present technology focuses on a molecular structure inside a three-dimensional structure (inside a modeled object), freely controls physical properties of the three-dimensional structure (modeled object), and further expands the physical properties.

According to the present technology, physical properties of a three-dimensional structure can be freely controlled. More specifically, by arranging molecules, the physical properties of the three-dimensional structure, such as heat, light, and dynamics can be freely controlled three-dimensionally. As a result, an unprecedented material exhibiting anisotropy can be manufactured. Furthermore, according to the present technology, in a case where molecular orientation is controlled using a photosensitive material having a photosensitive group, the molecular orientation can be controlled more finely. By the way, arranging molecules means aligning directions of physical properties of the molecules.

Hereinafter, embodiments of the present technology will be described specifically and in detail.

### 2. First Embodiment (Example of Method for Manufacturing Three-Dimensional Structure)

A method for manufacturing a three-dimensional structure according to a first embodiment of the present technology (an example of a method for manufacturing a three-dimensional structure) includes orienting molecules of a first anisotropic material and/or molecules of a second anisotropic material while forming a layer containing the first anisotropic material and/or the second anisotropic material, in which the molecules of the first anisotropic material and/or the molecules of the second anisotropic material are repeatedly oriented a plurality of times while the layer is formed.

In the method for manufacturing a three-dimensional structure according to the first embodiment of the present technology, at least either of the molecules of the first anisotropic material and the molecules of the second anisotropic material are oriented, and at the same time, the layer is formed.

The first anisotropic material and the second anisotropic material each have a molecule having a skeleton that exhibits and/or amplifies anisotropy (a molecule having low symmetry). In addition, the molecular length of the first anisotropic material (for example, the length in a molecular major axis direction) is shorter than the molecular length of the second anisotropic material (for example, the length in a molecular major axis direction). The first anisotropic material and the second anisotropic material may each have liquid crystallinity or non-liquid crystallinity.

Examples of the first anisotropic material and the second anisotropic material include a molecule having a skeleton such as biphenyl, a molecule such as carbon nanotube (CNT) although being a large-scale material, and a magnetic material such as iron oxide. If these materials are left in the state of 2, they are in a state of being dispersed as a layer in, for example, an acrylic resin, but these materials may be in a state of being actively chemically bonded. In this case, an acryloyl group, a methacryloyl group, an epoxy group, or an oxetane group is added to an end of a molecule. In a case of a large-scale material, a polymerization or crosslinking group is similarly modified around the material. As described above, in a case where each of the first anisotropic material and the second anisotropic material is curable, a stable orientation state can be obtained for a long period of time after orientation is once performed. In a case where each of the first anisotropic material and the second anisotropic material is curable, each of the first anisotropic material and the second anisotropic material may have a polymerizable group and/or a crosslinkable group.

The first anisotropic material and the second anisotropic material may be each an oriented particle material, and examples thereof include an oriented particle material such as iron oxide, CNT, or nanocellulose fibers (CNF). Note that the first anisotropic material and the second anisotropic material may be each an oriented powder material. Examples of the oriented powder material include an oriented particle material such as iron oxide, CNT, or nanocellulose fibers (CNF).

In a case where each of the first anisotropic material and the second anisotropic material is an oriented particle material or an oriented powder material, the aspect ratio (average major axis length/average minor axis length) thereof is preferably 1.1 or more. This is because in a case where each of the first anisotropic material and the second anisotropic material is an oriented particle material or an oriented powder material, the anisotropy of each of the first anisotropic material and the second anisotropic material may depend on the shape of the particle or the shape of the powder.

The method for manufacturing a three-dimensional structure according to the first embodiment of the present technology (an example of a method for manufacturing a three-dimensional structure) may include orienting molecules of a first anisotropic material and/or molecules of a second anisotropic material while forming a layer containing the first anisotropic material and/or the second anisotropic material and a photosensitive material.

In the method for manufacturing a three-dimensional structure according to the first embodiment of the present technology, the photosensitive material is a molecule that causes a reaction such as direct deformation or crosslinking when receiving light. For example, azobenzene is transformed from a trans state to a cis state when receiving ultraviolet linearly polarized light. However, azobenzene absorbs only a component in a molecular major axis direction of azobenzene in the trans state out of the polarized light in a vibration direction. Therefore, if the vibration direction of the polarized light and the molecular major axis of azobenzene are parallel to each other, azobenzene absorbs all of the polarized light, and if they are perpendicular to each other, azobenzene does not absorb the polarized light. Azobenzene in the trans state becomes a cis state when absorbing ultraviolet linearly polarized light. However, since the cis state is not stable, azobenzene returns to the trans state by heat or visible light. When azobenzene returns to the trans state, if there is the same component as the irradiation linearly polarized light, azobenzene makes a transition to the cis state again. This is repeated until the ultraviolet linearly polarized light and the molecular major axis direction of azobenzene become perpendicular to each other. As a result, molecules of azobenzene are arranged in the trans state in a direction perpendicular to the ultraviolet linearly polarized light.

In another example, cinnamate absorbs ultraviolet linearly polarized light to be crosslinked. In the case of cinnamate, the directions of two phenyl rings after crosslinking are perpendicular to the vibration direction of the linearly polarized light. Therefore, as a result, molecules are arranged in a direction perpendicular to the emitted linearly polarized light.

The photosensitive material may be curable. The curable photosensitive material brings about a more stable orientation state for a long period of time.

The method for manufacturing a three-dimensional structure according to the first embodiment of the present technology (an example of a method for manufacturing a three-dimensional structure) may include orienting molecules of a first anisotropic material and/or molecules of a second anisotropic material while forming a layer containing the first anisotropic material and/or the second anisotropic material and at least one resin material, in which the layer may be formed using a photopolymerization initiator.

The method for manufacturing a three-dimensional structure according to the first embodiment of the present technology (an example of a method for manufacturing a three-dimensional structure) may include orienting molecules of a first anisotropic material and/or molecules of a second anisotropic material while forming a layer containing the first anisotropic material and/or the second anisotropic material, a photosensitive material, and at least one resin material, in which the layer may be formed using a photopolymerization initiator.

The at least one resin material may contain various polymerizable monomers (for example, photopolymerizable monomers) and/or polymerization initiators (for example, photopolymerization initiators) as base materials for forming a layer. In many cases, the at least one resin material basically does not have a molecular skeleton exhibiting anisotropy, and in a case where a layer is formed only with at least one resin material, there may be a possibility that each layer and a laminated cured product does not exhibit anisotropy.

The method for manufacturing a three-dimensional structure according to the first embodiment of the present technology (an example of a method for manufacturing a three-dimensional structure) may further include, in addition to orienting molecules of a first anisotropic material and/or molecules of a second anisotropic material while forming a layer, curing the layer and repeating these alternately.

In the method for manufacturing a three-dimensional structure according to the first embodiment of the present technology, forming a layer and curing the layer may be considered as different concepts. By forming a layer, the layer is cured, but curing is not necessarily sufficient. Chemically, for example, a case where the polymerization group is an acryloyl group indicates a state in which an unreacted acryloyl group remains. Moreover, if this state is a monofunctional monomer, the monofunctional monomer can freely move as a residual monomer, and if this state is a polyfunctional monomer, the polyfunctional monomer causes deformation or shrinkage of a structure by being polymerized later.

As a countermeasure against such a situation, in addition to a process of orienting molecules while forming a layer, a process of curing the layer is performed. Examples of a method for further curing the layer include a method for curing the layer with light. At this time, the wavelength of irradiation light only needs to be adapted to an absorption wavelength of a polymerization initiator, and light of 400 nm or more is desirable (of course, the absorption wavelength of the polymerization initiator includes 400 nm or more). This is because a three-dimensional structure turns yellow when being exposed to high-energy light. Meanwhile, in the process of orienting molecules, since an absorption wavelength of a photosensitive group is, for example, 360 nm for azobenzene and 313 nm for cinnamate, it is conceivable to make an irradiation wavelength in the process of orienting molecules while forming a layer different from that in the process of curing the layer. By placing emphasis on efficiency and device cost, the wavelength in the process of curing the layer may be the same as that in the process of orienting molecules, or a broadband wavelength band may be used. In a case where the broadband wavelength band is used, for example, a metal halide lamp or the like can be used.

The method for manufacturing a three-dimensional structure according to the first embodiment of the present technology may further include irradiating different regions in the formed layer (for example, regions having different positional relationships in the layer) with energy rays having different polarization directions (for example, ultraviolet rays). The method for manufacturing a three-dimensional structure according to the first embodiment of the present technology may include, in a case where a layer contains at least one resin material, forming the layer while controlling the temperature of the at least one uncured resin material out of the at least one resin material. This manufacturing method is a method for forming a layer in a state where the resin material is heated (the temperature thereof is controlled) with a heating mechanism in a tank. The resin material is heated because it may take time for anisotropic molecules to move due to the high viscosity of the resin, and presence of a mechanism to keep the temperature of the resin material constant makes coincidence between a design value and a structure better. Furthermore, by raising the temperature, solubility of various molecules in the resin can be increased, and more types of materials can be handled. Moreover, in a case of a substance having liquid crystallinity, it may be possible to increase orientation of molecules by using a temperature range of a liquid crystal phase.

In the process of orienting molecules while forming a layer for forming each layer, in a case of irradiation with an energy ray (for example, ultraviolet light), a molecular orientation direction is determined depending on a polarization direction of the irradiation ultraviolet light due to characteristics of a photosensitive group. For example, in azobenzene and cinnamate, molecules are arranged in a direction perpendicular to a polarization direction of irradiation ultraviolet light. Although it depends on an optical system of irradiation light, in a method using a galvanometer mirror and a method using a MEMS mirror, a plane is scanned with irradiation light. At this time, by causing the light to pass through a polarizing plate to change a polarization direction for each irradiation position, a molecular orientation distribution can be formed in a layer. Furthermore, in a projection method, the inside of a layer is subjected to batch exposure. At this time, by dividing an irradiation region into parts for each polarization direction and irradiating each layer with light a plurality of times, a molecular orientation distribution can be formed in the layer.

In the method for manufacturing a three-dimensional structure according to the first embodiment of the present technology, a layer may be formed by a stereolithography apparatus (SLA) method.

The stereolithography apparatus (SLA) method is the oldest method among methods for a 3D printer. The stereolithography apparatus (SLA) method was invented in Japan and was put into practical use by 3D Systems in 1987. The stereolithography apparatus (SLA) method is a modeling method using a liquid resin (photocurable resin) that is cured when being irradiated with ultraviolet rays.

In principle, a tank filled with a photocurable resin or the like is irradiated with an ultraviolet laser to form a layer. As for a modeling direction, there are a free liquid level method (light is applied from above) and a hanging method (light is applied from below). In addition, as for a light irradiation method, there are a projector method (an LCD element and a DLP element), a laser method (a galvanometer mirror and a MEMS mirror), and a liquid crystal panel (LCD) method (an LCD is attached to a bottom surface by the hanging method). In general, in the free liquid level method, when one layer is formed, a molding stage is lowered by one layer, and a plurality of layers is laminated to perform molding. It is difficult to ensure flatness of a liquid level, and the liquid level is exposed to air. Therefore, polymerization inhibition may be caused by oxygen (in this case, measures such as filling with N₂ atmosphere are required), and a large amount of resin liquid is required (a resin liquid in an amount corresponding to the height of an object to be formed is required). Meanwhile, in the hanging method, it is necessary to pull up a table, perform molding such that a modeled object hangs upside down, and peel off a bottom surface from a tank each time. Therefore, there are a method for surface-treating a bottom surface with fluorine or the like and peeling off a stage obliquely when the table is pulled up, and a method for allowing oxygen to permeate the tank intentionally and smoothly peeling off a stage without completely polymerizing a bottom surface.

In the method for manufacturing a three-dimensional structure according to the first embodiment of the present technology, a layer may be formed by an inkjet method.

The inkjet method is a method for spraying a liquid ultraviolet ray-curable resin and irradiating the resin with ultraviolet rays to laminate the resin. This is a modeling method to which the principle of an inkjet printer that prints paper is applied.

In principle, a liquefied resin is sprayed as in an inkjet printer and irradiated with ultraviolet rays to be cured. The cured resin is laminated in a plurality of layers to be modeled. In the inkjet method, a material discharged from a single nozzle (or a plurality of nozzles) is generally cured by the same (single) UV light. However, by irradiating the material discharged from the single nozzle (or the plurality of nozzles) with light while changing a vibration direction of polarized light a plurality of times, a molecular orientation distribution can be formed in a layer. By using the SLA method, an orientation distribution can be formed with a single material. However, if this idea is applied to the inkjet method, not only an orientation distribution but also a distribution with a plurality of materials can be formed. Moreover, by using the inkjet method, a material can be changed freely. Therefore, by printing conductive materials (an organic material, an inorganic material, and a metal material) at the same time, a circuit can be formed inside a three-dimensional structure.

In the method for manufacturing a three-dimensional structure according to the first embodiment of the present technology, a layer may be formed by a projection method.

As described above, the projection method is one type of SLA method, which is a method for curing and laminating a resin using light of a projector.

In the laser method, laser light is used for irradiation, whereas in the projection method, an entire modeling stage is irradiated with light of a projector. There is a mask that blocks light between a resin and the projector, and modeling is performed such that only a modeling part is exposed to light.

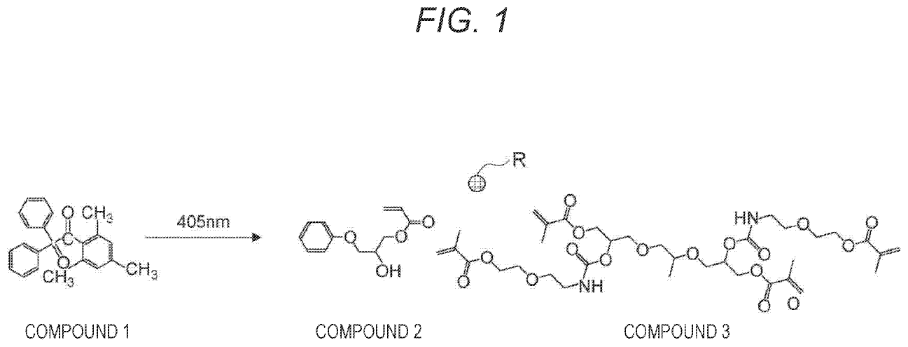

Hereinafter, the method for manufacturing a three-dimensional structure according to the first embodiment of the present technology will be described with reference to FIGS. 1 to 11.

First, description will be made with reference to FIG. 1. FIG. 1 is a diagram for explaining that a layer containing a resin material is formed using a photopolymerization initiator.

Diphenyl (2,4,6-trimethylbenzoyl) phosphine oxide (compound 1 in FIG. 1) as a photopolymerization initiator absorbs light around 400 nm (405 nm in FIG. 1) and generates radicals. Compound 1 is polymerized by a chain reaction with an acryloyl group of 2-hydroxy-3-phenoxypropylacrylate (compound 2 in FIG. 1) or urethane acrylate (compound 3 in FIG. 1) to form a layer containing a resin material. Note that as illustrated in FIG. 1, the resin material is schematically illustrated as a molecule R of the resin material.

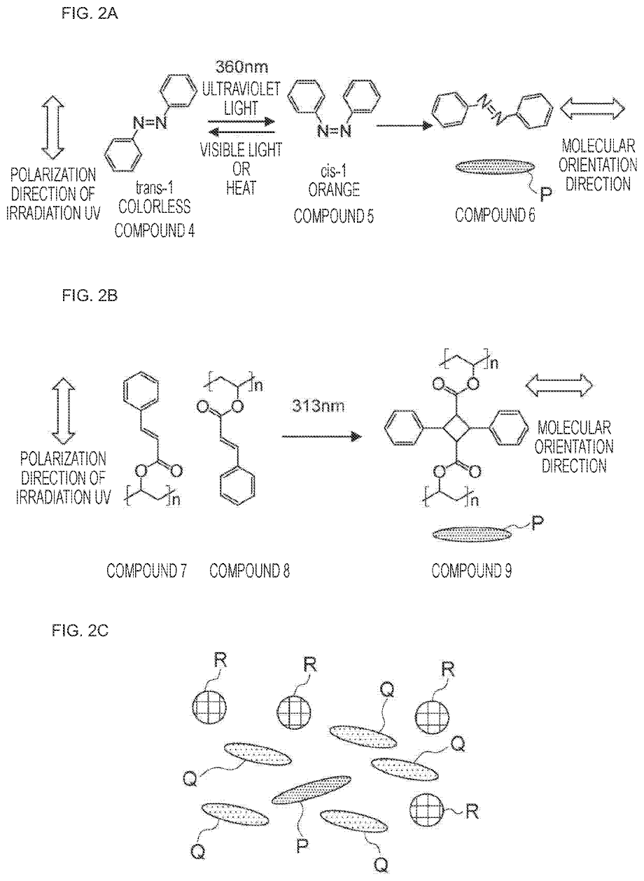

Next, description will be made with reference to FIG. 2. The material exhibiting photosensitive anisotropy illustrated in FIG. 2 can be used in combination with a general 3D printer material (for example, the above resin material). FIG. 2 is a diagram for explaining reactions of photosensitive materials (azobenzene and cinnamate). More specifically, FIG. 2(a) is a diagram illustrating a reaction (structural change) of azobenzene caused by light irradiation or heat. FIG. 2(b) is a diagram illustrating a reaction of cinnamate. FIG. 2(c) is a diagram schematically illustrating an arrangement state of a molecule P of a photosensitive material (azobenzene or cinnamate), a molecule Q of a first anisotropic material, and a molecule R of a resin material. Azobenzene alone is exemplified in FIG. 2(a), and a compound obtained by adding cinnamate to polyvinyl is exemplified in FIG. 2(b), but the present disclosure is not limited to these forms. For example, a compound obtained by adding an acryloyl group to azobenzene, or a compound obtained by adding a polymerization initiator to azobenzene may be used.

As illustrated in FIG. 2(a), azobenzene has an absorption peak around 360 nm and absorbs light in a vibration direction in a molecular major axis direction. In a case where linearly polarized light is tilted from a major axis direction of azobenzene, azobenzene absorbs a normal projection component of the polarized light on the molecular major axis. When azobenzene absorbs light, azobenzene makes a transition from a trans form (compound 4) to a cis form (compound 5). In general, azobenzene is more stable in the trans form. After transition to the cis form, azobenzene makes a transition to the trans form again by irradiation with visible light or heat. In the state where azobenzene has returned to the trans form by transition, azobenzene absorbs a normal projection component of the polarized light on the molecular major axis again and makes a transition to the cis form again. This is repeated until azobenzene no longer absorbs UV. One of the states where azobenzene no longer absorbs polarized ultraviolet light is when the vibration direction of the polarized light and the major axis direction of azobenzene are perpendicular to each other. In this state, azobenzene no longer absorbs ultraviolet light, and therefore azobenzene becomes stable in the trans form (compound 6). As a result, molecules of azobenzene are arranged in a direction perpendicular to the vibration direction of the polarized irradiation ultraviolet light. Furthermore, in a case where azobenzene is irradiated with parallel light whose vibration direction is random instead of the polarized light, azobenzene similarly repeats the cis-trans transition. However, unlike the case where azobenzene is irradiated with the linearly polarized light, molecules of azobenzene are oriented not in a plane perpendicular to a light travelling direction but finally in the light travelling direction. This is because if molecules of azobenzene are oriented in the light travelling direction, azobenzene no longer absorbs light.

Furthermore, as illustrated in FIG. 2(b), molecular anisotropy can be similarly exhibited by polarized ultraviolet light in cinnamate (compounds 7 and 8). A reaction of polyvinyl cinnamate due to polarized light is illustrated below. Similarly, cinnamate absorbs light of a vibration component in the same direction as the molecular major axis. An absorption peak is 313 nm. In a case where cinnamate absorbs ultraviolet light in the same direction as the molecular major axis, a molecule of cinnamate forms a dimer with a molecule of cinnamate that has similarly absorbed the ultraviolet light. When the dimer is formed, compound 9 has a structure centered on a four-membered ring sandwiched between two phenyl rings, and the molecule has anisotropy in a direction of the phenyl rings extending in these two directions.

Moreover, as illustrated in FIG. 2(c), the molecule P of the photosensitive material having a photosensitive group, such as cinnamate or azobenzene acquires anisotropy when being irradiated with polarized light. In a case where there is an anisotropic material such as a rod-shaped liquid crystal molecule (for example, the molecule Q of the first anisotropic material) in addition to the molecule P, anisotropy can be amplified by promoting orientation to the anisotropic material. In other words, this triggers exhibition of molecular anisotropy.

By the way, as illustrated in FIGS. 2(a) and 2(b), the photosensitive group reacts with ultraviolet light of 360 nm or 313 nm. Irradiation light for causing a reaction of the photosensitive group to exhibit anisotropy not only causes a reaction of the photosensitive group, but also cleaves a radical polymerization initiator for forming a layer. This is because the absorption spectrum of the radical polymerization initiator is generally broad on a low wavelength side. Therefore, in irradiation with ultraviolet light, a process of causing a reaction of the photosensitive group to exhibit anisotropy and a process of forming a layer by radical polymerization occur at the same time. Furthermore, the initiator does not function in some cases due to large absorption of the photosensitive group. In this case, by separating the reaction of the photosensitive group and the reaction of polymerization from each other using a bandpass filter or the like, formation of a layer and orientation of molecules can be each performed.

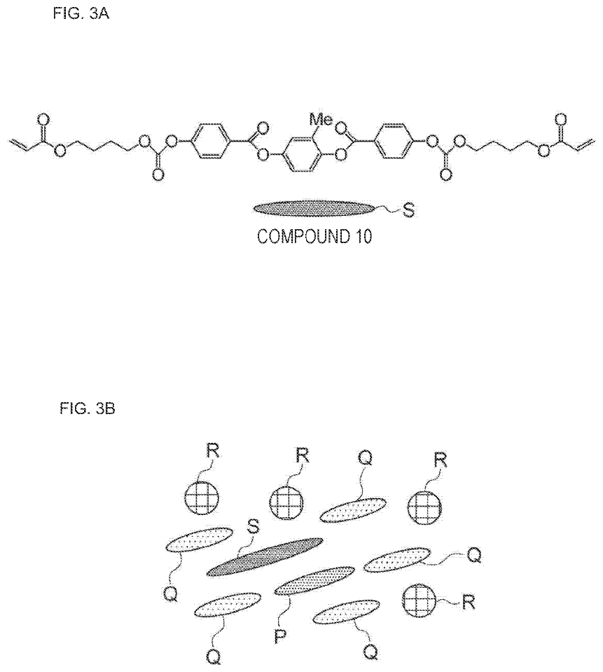

FIG. 3 is a diagram illustrating an example of the second anisotropic material. More specifically, FIG. 3(a) is a diagram illustrating compound 10 that is the second anisotropic material. FIG. 3(b) is a diagram schematically illustrating an arrangement state of the molecule P of the photosensitive material (azobenzene or cinnamate), the molecule Q of the first anisotropic material, the molecule R of the resin material, and a molecule S of the second anisotropic material (compound 10). As illustrated in FIG. 3(b), due to presence of the molecule P of the photosensitive material, the molecule Q of the first anisotropic material and the molecule S of the second anisotropic material are aligned in the same direction. The molecule P of the photosensitive material can arrange the molecule Q of the first anisotropic material and the molecule S of the second anisotropic material.

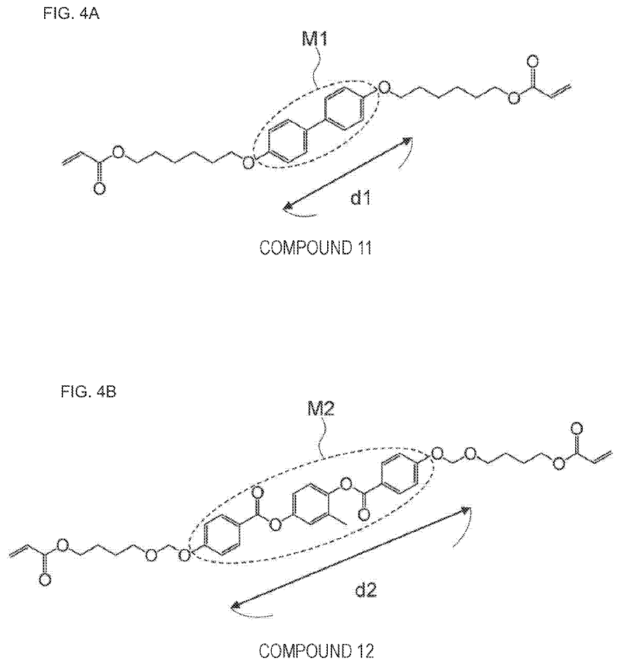

FIG. 4 is a diagram illustrating an example of the first anisotropic material and an example of the second anisotropic material. More specifically, FIG. 4(a) is a diagram illustrating compound 11 that is the first anisotropic material. FIG. 4(b) is a diagram illustrating compound 12 that is the second anisotropic material.

As illustrated in FIG. 4(a), compound 11 that is the first anisotropic material includes mesogen M1. As illustrated in FIG. 4(b), compound 12 that is the second anisotropic material includes mesogen M2. Mesogen is a rigid site exhibiting liquid crystallinity, and is also called a mesogen group. Examples of the most basic rod-shaped mesogen group include biphenyl and phenylbenzoate structures.

As illustrated in FIGS. 4(a) and 4(b), the length d2 of mesogen M2 included in compound 12 that is the second anisotropic material is longer than the length d1 of mesogen M1 included in compound 11 that is the first anisotropic material. That is, the molecular length (length in the molecular major axis direction) of compound 12 that is the second anisotropic material is longer than the molecular length (length in the molecular major axis direction) of compound 11 that is the first anisotropic material. Therefore, the second anisotropic material is more anisotropic than the first anisotropic material. Note that the first anisotropic material and the second anisotropic material may each have liquid crystallinity or non-liquid crystallinity.

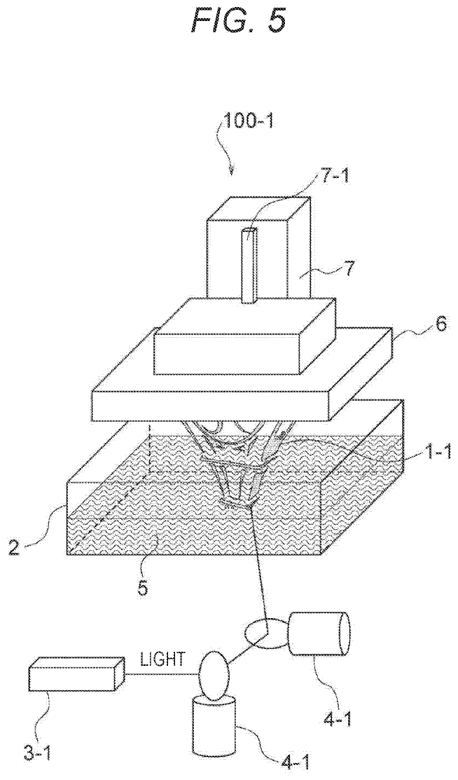

FIG. 5 is a configuration example of a 3D printer device capable of using the method for manufacturing a three-dimensional structure according to the first embodiment of the present technology, and more specifically a diagram illustrating an SLA type 3D printer device 100-1 using a laser and a galvanometer mirror and capable of using a method for manufacturing a three-dimensional structure 1-1.

The 3D printer device 100-1 includes a tank 2 containing a three-dimensional structure forming liquid 5 for forming the three-dimensional structure 1-1, a laser 3-1, two galvanometer mirrors 4-1, a stage 6, and a vertical drive device 7 including a vertical drive unit 7-1. The 3D printer device 100-1 may include a polarizing plate (not illustrated in FIG. 5) between the tank 2 and the galvanometer mirror 4-1 (galvanometer mirror 4-1 on the tank 2 side). The three-dimensional structure forming liquid 5 may be an uncured resin (polymer) or a monomer liquid. Furthermore, the three-dimensional structure forming liquid 5 may contain a photopolymerization initiator.

The 3D printer device 100-1 is pulled up by the vertical drive device 7 including the vertical drive unit 7-1, and causes light output from the laser 3-1 to be reflected on the galvanometer mirrors 4-1 and emits the light in order to form a layer (layer constituting the three-dimensional structure 1-1) from a bottom surface of the tank 2. That is, the bottom surface (surface on which one layer of uncured resin is prepared) of the tank 2 is scanned by the laser 3-1. When the layer (layer constituting the three-dimensional structure 1-1) is formed, the stage 6 is pulled up, and uncured resin is poured between the bottom surface and the cured resin layer (layer constituting the three-dimensional structure 1-1). Then, furthermore, light for forming a layer (layer constituting the three-dimensional structure 1-1) is emitted again.

As described above, when the 3D printer device 100-1 includes a polarizing plate between the galvanometer mirror 4-1 and the tank 2, if the polarizing plate is rotated for each irradiation region, the three-dimensional structure 1-1 having any molecular orientation direction can be formed for each region.

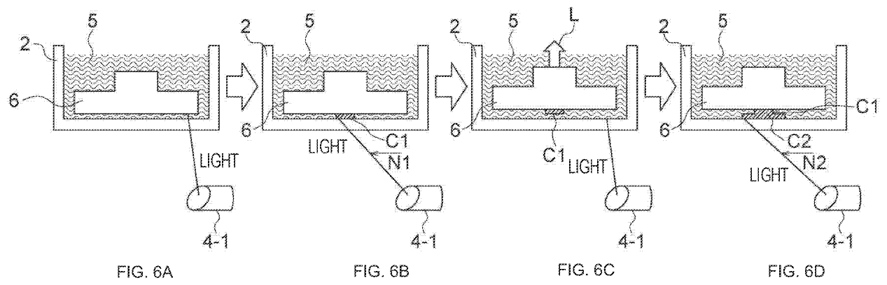

FIG. 6 is a diagram for explaining that the three-dimensional structure 1-1 is manufactured using the 3D printer device 100-1.

As illustrated in FIG. 6(a), light output from the laser 3-1 is reflected on the galvanometer mirror 4-1, and the three-dimensional structure forming liquid 5 is irradiated with the light. As illustrated in FIG. 6(b), scanning with light is performed in the direction of arrow N1 to form a layer C1. As illustrated in FIG. 6(c), the stage 6 is moved in the direction of arrow L (upward in FIG. 6(c)), and the three-dimensional structure forming liquid 5 between the bottom surface of the tank 2 and the layer C1 is irradiated with light. Then, as illustrated in FIG. 6(d), scanning with light is performed in the direction of arrow N2 to form a layer C2 below the layer C1. The above operation is repeated to manufacture the three-dimensional structure 1-1.

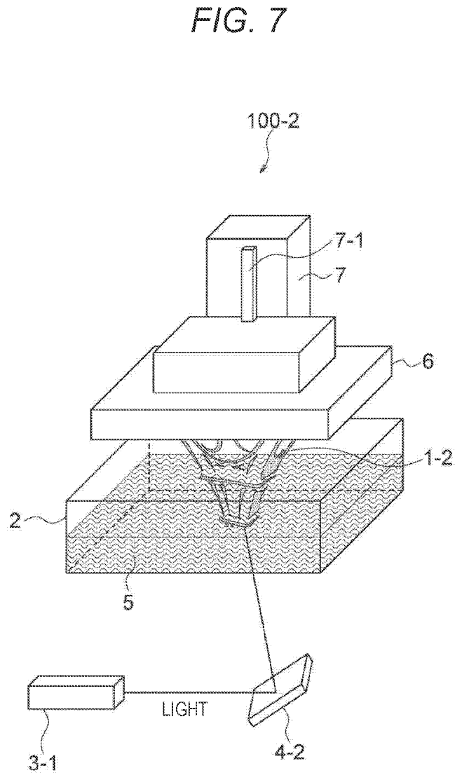

FIG. 7 is a configuration example of a 3D printer device capable of using the method for manufacturing a three-dimensional structure according to the first embodiment of the present technology, and more specifically a diagram illustrating an SLA type 3D printer device 100-2 using a MEMS mirror 4-2 and capable of using a method for manufacturing a three-dimensional structure 1-2.

The 3D printer device 100-2 includes a tank 2 containing a three-dimensional structure forming liquid 5 for forming the three-dimensional structure 1-2, a laser 3-1, the MEMS mirror 4-2, a stage 6, and a vertical drive device 7 including a vertical drive unit 7-1. The 3D printer device 100-2 may include a polarizing plate (not illustrated in FIG. 7) between the tank 2 and the MEMS mirror 4-2.

The method for manufacturing (modeling) the three-dimensional structure 1-2 is the same as the method for manufacturing (modeling) the three-dimensional structure 1-1 using the 3D printer device 100-1. By using the MEMS mirror 4-2, space can be saved, and cost can be reduced.

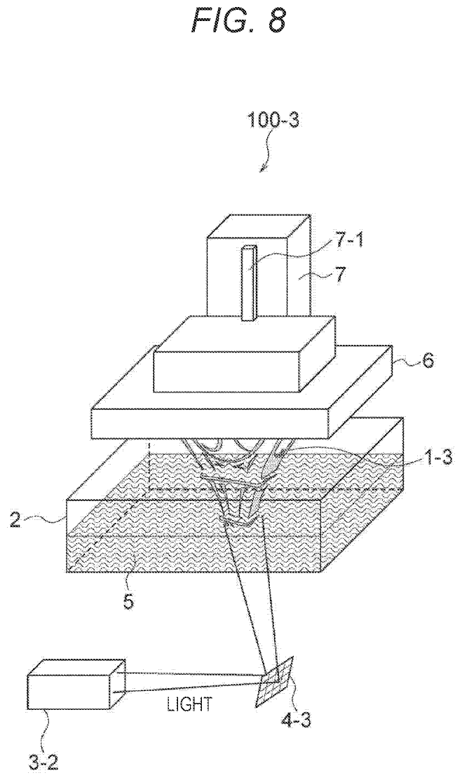

FIG. 8 is a configuration example of a 3D printer device capable of using the method for manufacturing a three-dimensional structure according to the first embodiment of the present technology, and more specifically a diagram illustrating an SLA type 3D printer device 100-3 using DLP and capable of using a method for manufacturing a three-dimensional structure 1-3.

The 3D printer device 100-3 includes a tank 2 containing a three-dimensional structure forming liquid 5 for forming the three-dimensional structure 1-3, a light source 3-2 (for example, a laser or LED), DLP 4-3, a stage 6, and a vertical drive device 7 including a vertical drive unit 7-1. The 3D printer device 100-3 may include a polarizing plate (not illustrated in FIG. 8) between the tank 2 and the DLP 4-3.

The DLP 4-3 is one type of MEMS mirror 4-2. While the MEMS mirror 4-2 constituting the 3D printer device 100-2 is a single plate, the DLP 4-3 has a configuration in which a plurality of mirrors is arranged. Therefore, uncured resin (which may be the three-dimensional structure forming liquid 5) on a bottom surface of the tank 2 can be subjected to batch exposure. Although DLP is beginning to be used as an element for a 3D printer, a main application is a projector.

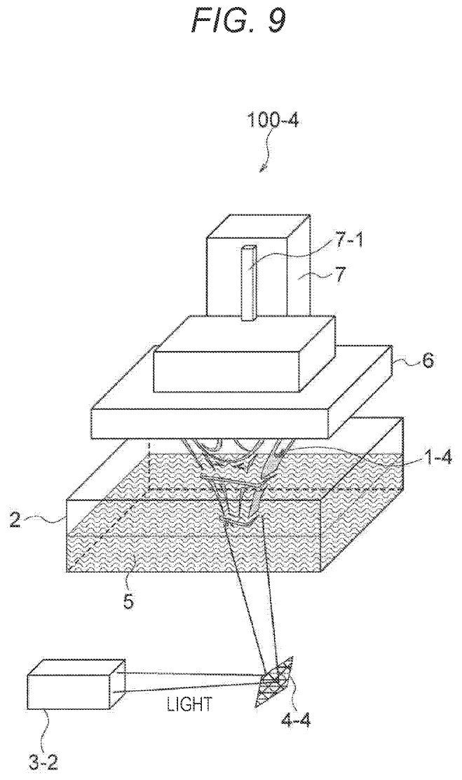

FIG. 9 is a configuration example of a 3D printer device capable of using the method for manufacturing a three-dimensional structure according to the first embodiment of the present technology, and more specifically a diagram illustrating an SLA type 3D printer device 100-4 using a liquid crystal projector method and capable of using a method for manufacturing a three-dimensional structure 1-4.

The 3D printer device 100-4 includes a tank 2 containing a three-dimensional structure forming liquid 5 for forming the three-dimensional structure 1-4, a light source 3-2 (for example, a laser or LED), LCoS 4-4, a stage 6, and a vertical drive device 7 including a vertical drive unit 7-1. The 3D printer device 100-4 may include a polarizing plate (not illustrated in FIG. 9) between the tank 2 and the LCoS 4-4.

The LCoS 4-4 is a reflective projector element like the DLP 4-3. The LCoS 4-4 is used by reflecting light on a mirror disposed on a silicon substrate. TFT is attached to each pixel, and display is switched by turning a liquid crystal on and off. When the LCoS 4-4 is used for a 3D printer, an irradiation location and a non-irradiation location are switched similarly. Furthermore, like the DLP 4-3, batch exposure is possible, and molding time (time for manufacturing the three-dimensional structures 1-4) can be shortened.

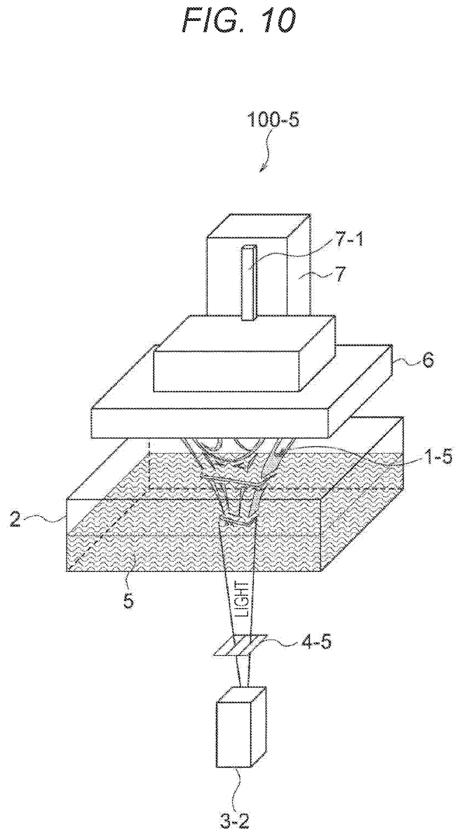

FIG. 10 is a configuration example of a 3D printer device capable of using the method for manufacturing a three-dimensional structure according to the first embodiment of the present technology, and more specifically a diagram illustrating an SLA type 3D printer device 100-5 using a liquid crystal projector method and capable of using a method for manufacturing a three-dimensional structure 1-5.

The 3D printer device 100-5 includes a tank 2 containing a three-dimensional structure forming liquid 5 for forming the three-dimensional structure 1-5, a light source 3-2 (for example, a laser or LED), HPLC 4-5, a stage 6, and a vertical drive device 7 including a vertical drive unit 7-1. The 3D printer device 100-5 may include a polarizing plate (not illustrated in FIG. 10) between the tank 2 and the HPLC 4-5.

The HPLC 4-5 is used as a liquid crystal projector element like the LCoS 4-4, but is a transmissive type. Similarly, display is switched by turning a liquid crystal on and off. When the HPLC 4-5 is used for a 3D printer, an irradiation location and a non-irradiation location are switched similarly. Furthermore, like the DLP 4-3, batch exposure is possible, and molding time can be shortened.

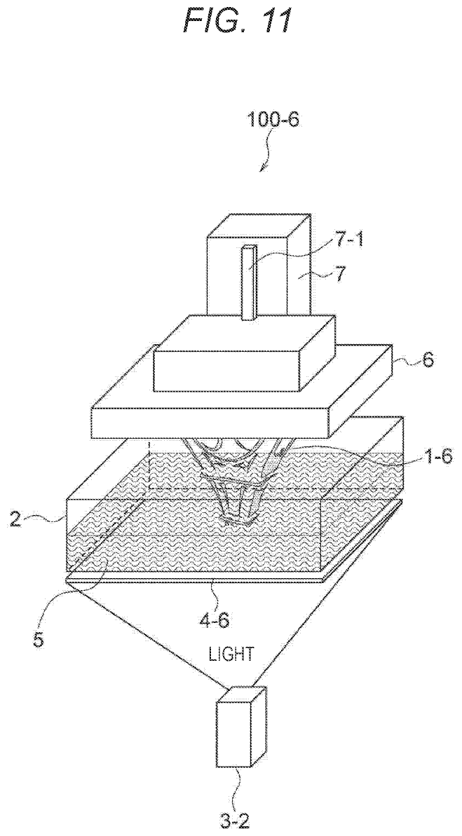

FIG. 11 is a configuration example of a 3D printer device capable of using the method for manufacturing a three-dimensional structure according to the first embodiment of the present technology, and more specifically a diagram illustrating an SLA type 3D printer device 100-6 using a liquid crystal panel method and capable of using a method for manufacturing a three-dimensional structure 1-6.

The 3D printer device 100-6 includes a tank 2 containing a three-dimensional structure forming liquid 5 for forming the three-dimensional structure 1-6, a light source 3-2 (for example, LED), a liquid crystal panel 4-6, a stage 6, and a vertical drive device 7 including a vertical drive unit 7-1. The 3D printer device 100-6 may include a polarizing plate (not illustrated in FIG. 10) between the tank 2 and the liquid crystal panel 4-6.

The 3D printer device 100-6 is a 3D printer called an LCD type. LCD is directly attached to a bottom of a resin tank, and the liquid crystal panel 4-6 acts as a light shutter to determine an irradiation region on the bottom surface of the resin tank. The resolution of the liquid crystal panel 4-6 becomes the resolution of a modeled object as it is.

### 3. Second Embodiment (Example of Three-Dimensional Structure)

A three-dimensional structure according to a second embodiment of the present technology (an example of a three-dimensional structure) is obtained by the method for manufacturing a three-dimensional structure according to the first embodiment of the present technology.

More specifically, the three-dimensional structure according to the second embodiment of the present technology (an example of a three-dimensional structure) has, as a first aspect, a molecular orientation distribution in at least one layer. The three-dimensional structure according to the first aspect of the second embodiment of the present technology is obtained by the method for manufacturing a three-dimensional structure according to the first embodiment of the present technology, the method including at least irradiating different regions in the formed layer (for example, regions having different positional relationships in the layer) with energy rays having different polarization directions.

The three-dimensional structure according to the second embodiment of the present technology (an example of a three-dimensional structure) has, as a second aspect, an unoriented region in at least one layer. The three-dimensional structure according to the second aspect of the second embodiment of the present technology is obtained by the method for manufacturing a three-dimensional structure according to the first embodiment of the present technology, the method including at least irradiating different regions in the formed layer (for example, regions having different positional relationships in the layer) with energy rays (for example, ultraviolet rays) having different polarization directions, and further including irradiating the different regions with unpolarized energy rays (for example, ultraviolet rays) in a random light state in order to form an unoriented region.

The three-dimensional structure according to the second aspect of the second embodiment of the present technology may include a region having refractive index anisotropy. As described above, in the three-dimensional structure according to the second aspect of the second embodiment of the present technology, an unoriented region may be formed, and an oriented region may be further formed. Having refractive index anisotropy in an orientated region means that the orientated region is transparent to light having a certain wavelength and moreover has refractive index anisotropy in the region.

The three-dimensional structure according to the second embodiment of the present technology (an example of a three-dimensional structure) is, as a third aspect, transparent to an electromagnetic wave in any wavelength band. The three-dimensional structure according to the third aspect of the second embodiment of the present technology is obtained by the method for manufacturing a three-dimensional structure according to the first embodiment of the present technology.

In the three-dimensional structure according to the third aspect of the second embodiment of the present technology, being transparent to light in any wavelength band means that it is only required to be transparent to light in a specific wavelength band. For example, a substance having liquid crystallinity has high transparency to a radio wave in a 5 GHz band. Therefore, it can be said that the substance having liquid crystallinity is transparent to light having a wavelength of about 60 mm. Furthermore, the three-dimensional structure may be transparent to visible light, infrared light, and the like.

### EXAMPLES

Hereinafter, the effects of the present technology will be specifically described with reference to Examples. Note that the scope of the present technology is not limited to the Examples.

Materials used in Examples 1 to 4 will be described. The materials used in Examples 1 to 4 are compounds represented by the following chemical formulas.

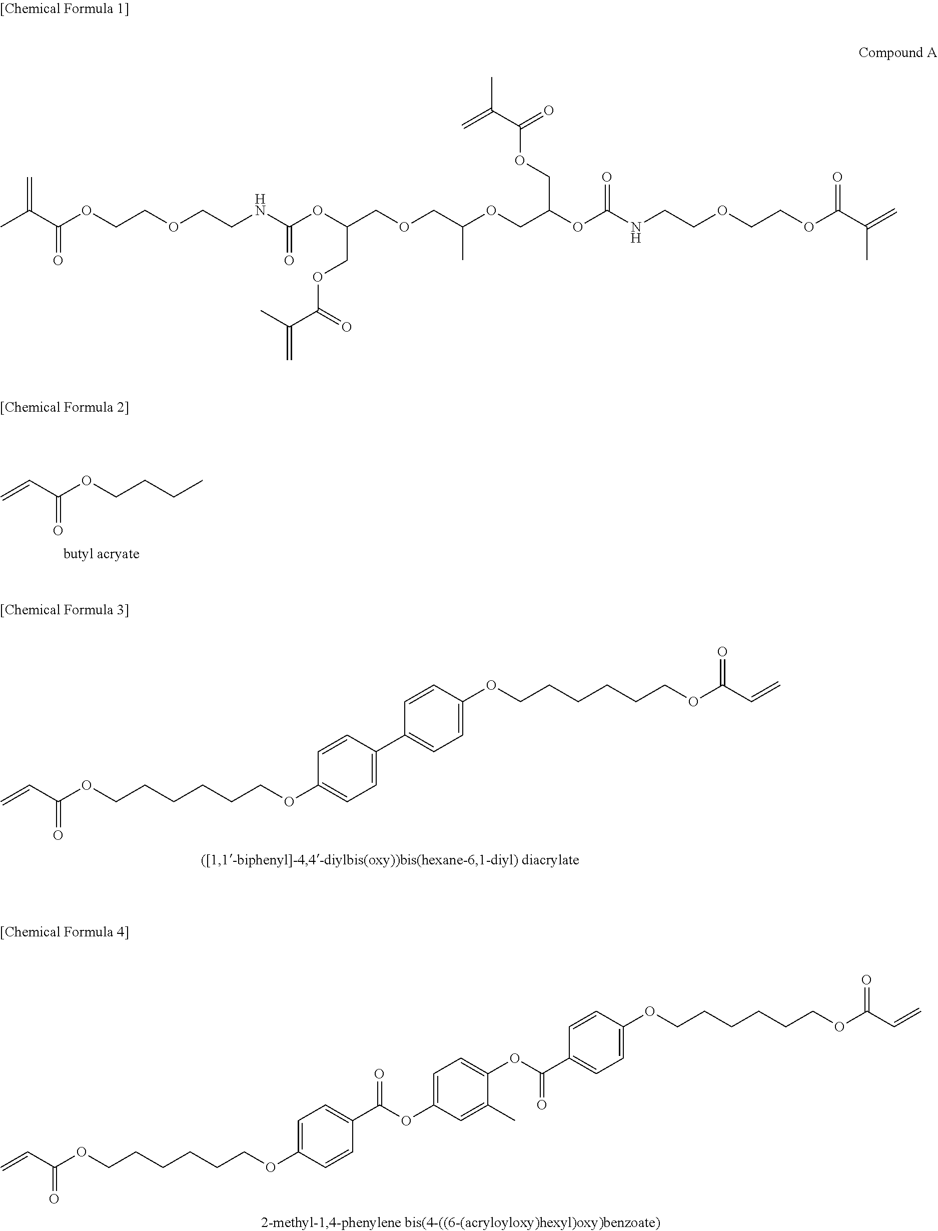

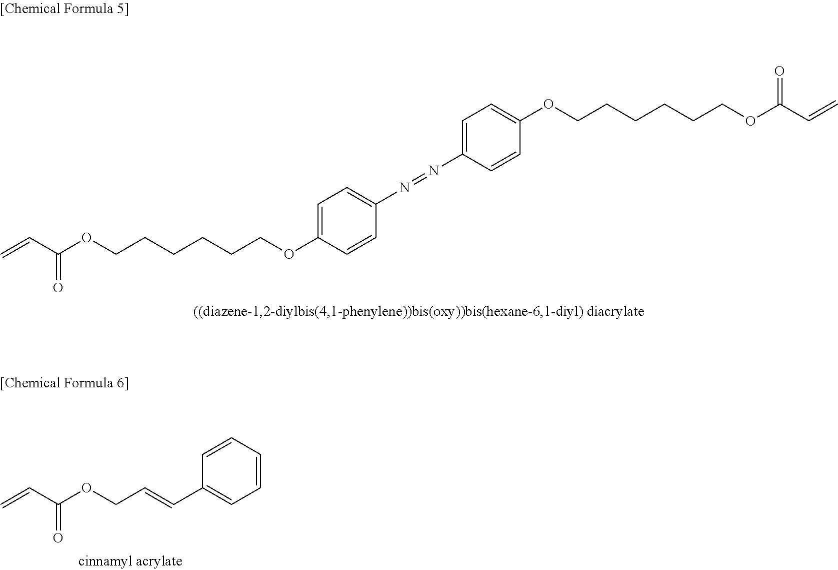

### Example 1

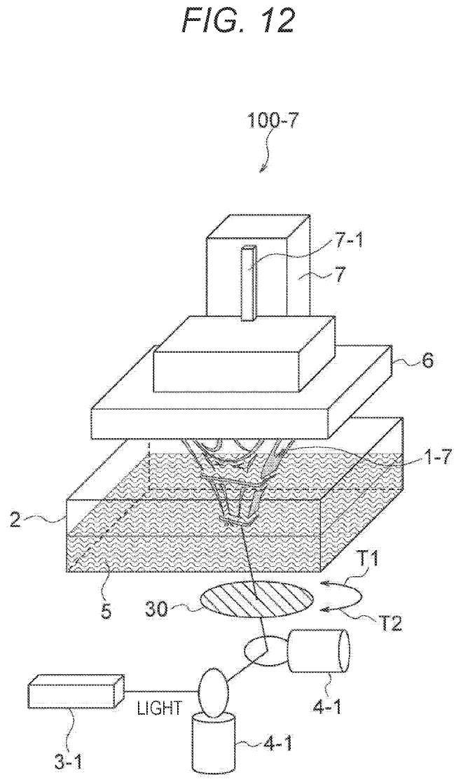

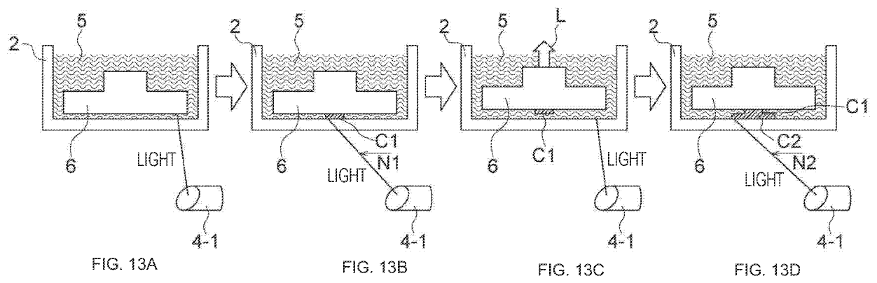

First, Example 1 will be described with reference to FIGS. 12 and 13.

FIG. 12 illustrates an example of a 3D printer device used in Example 1. A 3D printer device 100-7 illustrated in FIG. 12 manufactures a three-dimensional structure 1-7. The 3D printer device 100-7 includes a tank 2 containing a three-dimensional structure forming liquid 5 for forming the three-dimensional structure 1-7, a laser 3-1, two galvanometer mirrors 4-1, a stage 6, a vertical drive device 7 including a vertical drive unit 7-1, and a polarizing plate 30 disposed between the tank 2 and the galvanometer mirror 4-1 (galvanometer mirror 4-1 on the tank 2 side). Note that the three-dimensional structure forming liquid 5 may be an uncured resin (polymer) or a monomer liquid, and the polarizing plate 30 can freely form any molecular orientation direction in any region in the three-dimensional structure 1-7 by rotating counterclockwise (in an arrow T1 direction) or clockwise (in an arrow T2 direction).

FIG. 13 is a diagram illustrating an example for explaining that the three-dimensional structure 1-7 is manufactured using the 3D printer device 100-7.

As illustrated in FIG. 13(a), light output from the laser 3-1 is reflected on the galvanometer mirror 4-1, and the three-dimensional structure forming liquid 5 is irradiated with the light. As illustrated in FIG. 13(b), scanning with light is performed in the direction of arrow N1 to form a layer C1. As illustrated in FIG. 13(c), the stage 6 is moved in the direction of arrow L (upward in FIG. 13(c)), and the three-dimensional structure forming liquid 5 between the bottom surface of the tank 2 and the layer C1 is irradiated with light. Then, as illustrated in FIG. 13(d), scanning with light is performed in the direction of arrow N2 to form the layer C2 below the layer C1. The above operation is repeated to manufacture the three-dimensional structure 1-7 constituted by a plurality of layers.

Hereinafter, Example 1 will be described in detail.

A modeling stage (stage 6, the same applies hereinafter in Examples 1 to 4) was submerged in a tank (tank 2, the same applies hereinafter in Examples 1 to 4) filled with a resin (three-dimensional structure forming liquid 5, the same applies hereinafter in Examples 1 to 4) obtained by mixing a binder material (resin material) (mixture of compound A and butyl acrylate) and anisotropic molecules (([1,1′-biphenyl]-4,4′-diylbis(oxy)) bis(hexane-6,1-diyl) diacrylate) (first anisotropic material), and a space of 10 μm was formed between a bottom of the tank and the stage.

The space of 10 μm filled with the resin formed here was irradiated with ultraviolet light. At this time, a modeled object can be formed by scanning with laser light using a galvanometer mirror (galvanometer mirror 4-1; the same applies hereinafter in Examples 1 to 4) or patterning with a projector light source. Furthermore, the irradiation ultraviolet light needs to be polarized light. This is because the direction of molecules to be arranged is determined according to the direction of the polarized light. The outer shape is determined by patterning of a light source for irradiation, and at the same time, the direction of molecules in a formed layer can be freely determined by changing the direction of the polarized light each time. The resolution in the case of laser light depends on a beam diameter of the laser light. By rotating the polarizing plate according to a laser scanning flow, it is possible to form an arrangement of molecules according to polarized light at the time of laser scanning. Furthermore, in the case of a projector lamp, the inside of a layer is subjected to batch exposure. Therefore, it is only required to perform exposure as many times as the number corresponding to the types of the directions of molecules to be formed and to change the direction of the polarizing plate each time.

In formation of a second layer, the stage was pulled up by 10 μm, and a space of 10 μm was formed between the first layer formed and the bottom of the tank. Similar to the first layer, the space of 10 μm filled with the resin formed here was irradiated with ultraviolet light.

This operation was repeated for the third and subsequent layers, and the three-dimensional structure 1-7 was manufactured in which molecules in the structure (in this case, molecules of [1,1′-biphenyl]-4,4′-diylbis(oxy))bis(hexane-6,1-diyl) diacrylate were aligned).

In order to confirm the molecular orientation state in a layer, a laminate of several layers was formed, sandwiched between polarizing plates in a crossed Nicols state, and confirmed. As a result, it was confirmed that molecules (([1,1′-biphenyl]-4,4′-diylbis(oxy))bis(hexane-6,1-diyl) diacrylate) in the modeled object (in the three-dimensional structure 1-7) were arranged because more light passed through the modeled object in a case where the modeled object was put from a direction shifted by 45° from an absorption axis direction of the polarizing plates than in a case where the absorption axis direction of the polarizing plates and a direction in which the molecules were considered to be arranged coincided with each other.

### Example 2

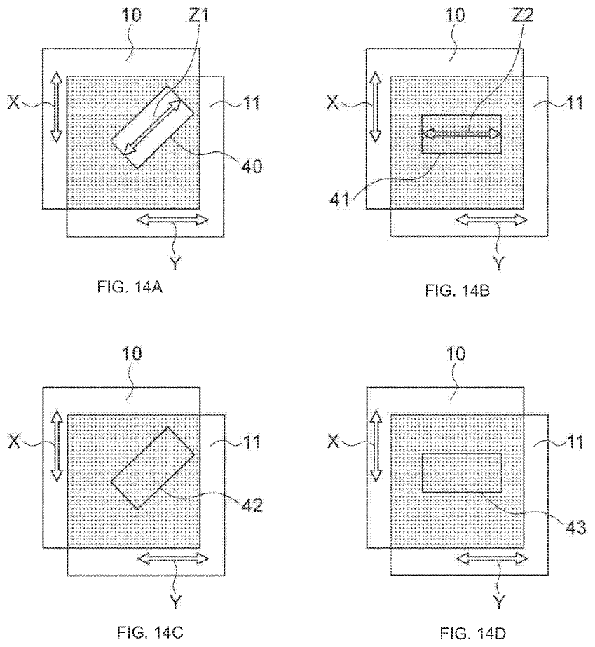

First, with reference to FIG. 14, it will be described that a molecular orientation state can be confirmed using a crossed Nicols polarizing plate.

As illustrated in FIG. 14(a), when an anisotropic material 40 is disposed between a crossed Nicols polarizing plate 10 (in which the light absorption axis is an X direction, the up-down direction in FIG. 14) and a crossed Nicols polarizing plate 11 (in which the light absorption axis is a Y direction, the left-right direction in FIG. 14) such that a molecular orientation direction Z1 is oblique (for example, 45°), it can be confirmed that light passes through the anisotropic material 40.

As illustrated in FIG. 14(b), when an anisotropic material 41 is disposed between a crossed Nicols polarizing plate 10 (in which the light absorption axis is an X direction, the up-down direction in FIG. 14) and a crossed Nicols polarizing plate 11 (in which the light absorption axis is a Y direction, the left-right direction in FIG. 14) such that a molecular orientation direction Z2 is horizontal (left-right direction in FIG. 14(b), it can be confirmed that light does not pass through the anisotropic material 41.

As illustrated in FIG. 14(c), when an isotropic material 42 is disposed between a crossed Nicols polarizing plate 10 (in which the light absorption axis is an X direction, the up-down direction in FIG. 14) and a crossed Nicols polarizing plate 11 (in which the light absorption axis is a Y direction, the left-right direction in FIG. 14) such that the isotropic material 42 itself is oblique (for example 45°) (such that the isotropic material 42 is disposed in a similar manner to the anisotropic material 40), it can be confirmed that light does not passes through the isotropic material 42.

As illustrated in FIG. 14(d), when an isotropic material 43 is disposed between a crossed Nicols polarizing plate 10 (in which the light absorption axis is an X direction, the up-down direction in FIG. 14) and a crossed Nicols polarizing plate 11 (in which the light absorption axis is a Y direction, the left-right direction in FIG. 14) such that the isotropic material 42 itself is horizontal (the left-right direction in FIG. 14(b)) (such that the isotropic material 43 is disposed in a similar manner to the anisotropic material 41), it can be confirmed that light does not passes through the isotropic material 43.

Next, Example 2 will be described.

A three-dimensional structure was manufactured in a similar manner to the method in Example 1 except that a resin obtained by mixing a binder material (resin material) (mixture of compound A and butyl acrylate) and anisotropic molecules having larger anisotropy than the anisotropic molecules used in Example (2-methyl-1,4-phenylene bis(4-((6-(acryloyloxy)hexyl)oxy)benzoate)) (second anisotropic material) was used.

In order to confirm the molecular orientation state in a layer, a laminate of several layers was formed, sandwiched between polarizing plates 10 and 11 in a crossed Nicols state as illustrated in FIG. 14, and confirmed. As a result, it was confirmed that molecules (2-methyl-1,4-phenylene bis(4-((6-(acryloyloxy)hexyl)oxy)benzoate)) in the modeled object were arranged, and the obtained modeled object (three-dimensional structure) had a larger birefringence than the modeled object (three-dimensional structure 1-7) in Example 1 because more light passed through the modeled object as compared with the modeled object (three-dimensional structure 1-7) in Example 1 in a case where the modeled object (three-dimensional structure) was put from a direction shifted by 45° from an absorption axis direction of the polarizing plates (for example, an arrangement relation illustrated in FIG. 14(a)) than in a case where the absorption axis direction of the polarizing plates and a direction in which the molecules were considered to be arranged coincided with each other (for example, an arrangement relation illustrated in FIG. 14(b)).

### Example 3

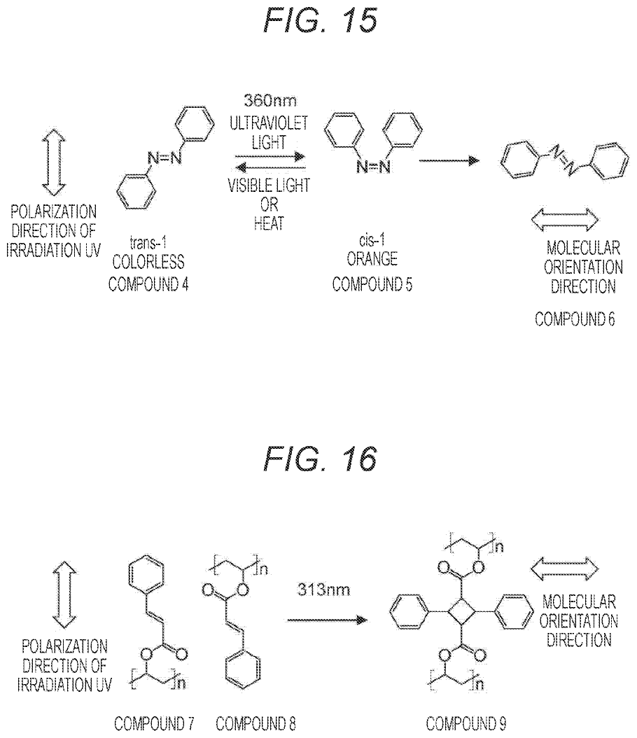

First, control of molecular orientation by azobenzene will be described with reference to FIG. 15. FIG. 15 is a diagram illustrating a reaction (structural change) of azobenzene caused by light irradiation or heat.

As illustrated in FIG. 15, when azobenzene is continuously exposed to ultraviolet light and visible light, azobenzene makes a cis-trans transition repeatedly. As long as azobenzene has a component in the same direction as a vibration direction of irradiation linearly polarized light UV, azobenzene continuously makes a cis-trans transition. However, when molecules of azobenzene are oriented in a direction perpendicular to the direction of the irradiation linearly polarized light UV, azobenzene can no longer absorb UV. Therefore, the transition stops in a trans state. In this way, molecules of azobenzene are oriented in a direction perpendicular to the irradiation linearly polarized light UV. Anisotropic molecules are also aligned in the direction in which molecules of azobenzene are oriented.

Next, Example 3 will be described.

A three-dimensional structure was manufactured in a similar manner to the method in Example 2 except that a resin obtained by mixing a binder material (resin material) (mixture of compound A and butyl acrylate), anisotropic molecules having larger anisotropy than the anisotropic molecules used in Example (2-methyl-1,4-phenylene bis(4-((6-(acryloyloxy)hexyl)oxy)benzoate)) (second anisotropic material), and an azo-based compound (((diazene-1,2-diylbis(4,1-phenylene))bis(oxy))bis(hexane-6,1-diyl) diacrylate) was used.

In order to confirm the molecular orientation state in a layer, a laminate of several layers was formed, sandwiched between polarizing plates in a crossed Nicols state, and confirmed. As a result, it was confirmed that molecules (2-methyl-1,4-phenylene bis(4-((6-(acryloyloxy)hexyl)oxy)benzoate)) in the modeled object were arranged, and the modeled object (three-dimensional structure) obtained in Example 3 had a larger birefringence than the modeled object (three-dimensional structure) obtained in Example 2 because more light passed through the modeled object as compared with the modeled object (three-dimensional structure) in Example 2 in a case where the modeled object was put from a direction shifted by 45° from an absorption axis direction of the polarizing plates than in a case where the absorption axis direction of the polarizing plates and a direction in which the molecules were considered to be arranged coincided with each other.

A reason why the modeled object (three-dimensional structure) in Example 3 has a larger birefringence than the modeled object (three-dimensional structure) in Example 2 is considered to be that molecules are more aligned (the order of molecular orientation is increased) by adding azobenzene.

### Example 4

First, control of molecular orientation by a cinnamate-based material will be described with reference to FIG. 16. FIG. 16 is a diagram illustrating a reaction of cinnamate.

As illustrated in FIG. 16, when a cinnamate-based material is irradiated with linearly polarized light, a cinnamoyl group forms a four-membered ring at the center such that a benzene ring is oriented in a direction perpendicular to the linearly polarized light. In this way, anisotropic molecules are also aligned in the direction in which the benzene ring is oriented.

Next, Example 4 will be described.

A three-dimensional structure was manufactured in a similar manner to the method in Example 2 except that a resin obtained by mixing a binder material (resin material) (mixture of compound A and butyl acrylate), anisotropic molecules having larger anisotropy than the anisotropic molecules used in Example (2-methyl-1,4-phenylene bis(4-((6-(acryloyloxy)hexyl)oxy)benzoate)) (second anisotropic material), and cinnamyl acrylate was used.

In order to confirm the molecular orientation state in a layer, a laminate of several layers was formed, sandwiched between polarizing plates in a crossed Nicols state, and confirmed. As a result, it was confirmed that molecules (2-methyl-1,4-phenylene bis(4-((6-(acryloyloxy)hexyl)oxy)benzoate)) in the modeled object (in the three-dimensional structure) were arranged, and the modeled object (three-dimensional structure) obtained in Example 4 had a larger birefringence than the modeled object (three-dimensional structure) in Example 2 because more light passed through the modeled object as compared with the modeled object (three-dimensional structure) in Example 2 in a case where the modeled object was put from a direction shifted by 45° from an absorption axis direction of the polarizing plates than in a case where the absorption axis direction of the polarizing plates and a direction in which the molecules were considered to be arranged coincided with each other.

A reason why the modeled object (three-dimensional structure) in Example 4 has a larger birefringence than the modeled object (three-dimensional structure) in Example 2 is considered to be that molecules are more aligned (the order of molecular orientation is increased) by adding cinnamyl acrylate.

The present technology is not limited to the above embodiments and Examples, but can be changed without departing from the gist of the present technology.

Furthermore, the present technology can have the following configurations.

[1]

A method for manufacturing a three-dimensional structure, the method including orienting molecules of a first anisotropic material and/or molecules of a second anisotropic material while forming a layer containing the first anisotropic material and/or the second anisotropic material, in which

the molecules of the first anisotropic material and/or the molecules of the second anisotropic material are repeatedly oriented a plurality of times while the layer is formed.

[2]

The method for manufacturing a three-dimensional structure according to [1], in which the first anisotropic material is curable.

[3]

The method for manufacturing a three-dimensional structure according to [1] or [2], in which the first anisotropic material is an oriented particle material.

[4]

The method for manufacturing a three-dimensional structure according to [3], in which the oriented particle material has an aspect ratio (average major axis length/average minor axis length) of 1.1 or more.

[5]

The method for manufacturing a three-dimensional structure according to any one of [1] to [4], in which the second anisotropic material is curable.

[6]

The method for manufacturing a three-dimensional structure according to any one of [1] to [5], in which the second anisotropic material is an oriented particle material.

[7]

The method for manufacturing a three-dimensional structure according to [6], in which the oriented particle material has an aspect ratio (average major axis length/average minor axis length) of 1.1 or more.

[8]

The method for manufacturing a three-dimensional structure according to any one of [1] to [7], the method including orienting molecules of a first anisotropic material and/or molecules of a second anisotropic material while forming a layer containing the first anisotropic material and/or the second anisotropic material and a photosensitive material.

[9]

The method for manufacturing a three-dimensional structure according to [8], in which the photosensitive material is curable.

[10]

The method for manufacturing a three-dimensional structure according to any one of [1] to [9], the method including orienting molecules of a first anisotropic material and/or molecules of a second anisotropic material while forming a layer containing the first anisotropic material and/or the second anisotropic material and at least one resin material.

[11]

The method for manufacturing a three-dimensional structure according to any one of [10], the method including orienting molecules of the first anisotropic material and/or molecules of the second anisotropic material while forming the layer using a photopolymerization initiator.

[12]

The method for manufacturing a three-dimensional structure according to any one of [1] to [11], the method including orienting molecules of a first anisotropic material and/or molecules of a second anisotropic material while forming a layer containing the first anisotropic material and/or the second anisotropic material, a photosensitive material, and at least one resin material.

[13]

The method for manufacturing a three-dimensional structure according to [12], in which the photosensitive material is curable.

[14]

The method for manufacturing a three-dimensional structure according to [12] or [13], the method including orienting molecules of the first anisotropic material and/or molecules of the second anisotropic material while forming the layer using a photopolymerization initiator.

[15]

The method for manufacturing a three-dimensional structure according to any one of [1] to [14], the method further including curing the layer.

[16]

The method for manufacturing a three-dimensional structure according to any one of [1] to [15], in which the layer is formed by a stereolithography apparatus (SLA) method.

[17]

The method for manufacturing a three-dimensional structure according to any one of [1] to [15], in which the layer is formed by an inkjet method.

[18]

The method for manufacturing a three-dimensional structure according to any one of [1] to [15], in which the layer is formed by a projection method.

[19]

The method for manufacturing a three-dimensional structure according to any one of [1] to [18], the method further including irradiating different regions in the layer with energy rays having different polarization directions.

[20]

A three-dimensional structure obtained by the manufacturing method according to [19] and having a molecular orientation distribution in at least one of the layers.

[21]

A three-dimensional structure obtained by the manufacturing method according to [19] and having an unoriented region in at least one of the layers.

[22]

The three-dimensional structure according to [21], including a region having refractive index anisotropy.

[23]

A three-dimensional structure obtained by the manufacturing method according to any one of [1] to [19] and transparent to an electromagnetic wave in any wavelength band.

[24]

The method for manufacturing a three-dimensional structure according to any one of [1] to [19], in which

the layer contains at least one resin material, and

the method includes forming the layer while controlling the temperature of the at least one uncured resin material out of the at least one resin material.

### REFERENCE SIGNS LIST

(1-1, 1-2, 1-3, 1-4, 1-5, 1-6, 1-7) Three-dimensional structure
2 Tank
3-1 Laser
3-2 Light source
4-1 Galvanometer mirror
4-2 MEMS mirror
4-3 DLP
4-4 LCoS
4-5 HPLC
4-6 Liquid crystal panel
5 Three-dimensional structure forming liquid
6 Stage
7 Vertical drive device
7-1 Vertical drive unit
30 Polarizing plate
100 (100-1, 100-2, 100-3, 100-4, 100-5, 100-6, 100-7) 3D printer device.

1. A method for manufacturing a three-dimensional structure, the method comprising orienting molecules of a first anisotropic material and/or molecules of a second anisotropic material while forming a layer containing the first anisotropic material and/or the second anisotropic material, wherein
the molecules of the first anisotropic material and/or the molecules of the second anisotropic material are repeatedly oriented a plurality of times while the layer is formed.

2. The method for manufacturing a three-dimensional structure according to claim 1, wherein the first anisotropic material is curable.

3. The method for manufacturing a three-dimensional structure according to claim 1, wherein the first anisotropic material is an oriented particle material.

4. The method for manufacturing a three-dimensional structure according to claim 3, wherein the oriented particle material has an aspect ratio (average major axis length/average minor axis length) of 1.1 or more.

5. The method for manufacturing a three-dimensional structure according to claim 1, wherein the second anisotropic material is curable.

6. The method for manufacturing a three-dimensional structure according to claim 1, wherein the second anisotropic material is an oriented particle material.

7. The method for manufacturing a three-dimensional structure according to claim 6, wherein the oriented particle material has an aspect ratio (average major axis length/average minor axis length) of 1.1 or more.

8. The method for manufacturing a three-dimensional structure according to claim 1, the method comprising orienting molecules of a first anisotropic material and/or molecules of a second anisotropic material while forming a layer containing the first anisotropic material and/or the second anisotropic material and a photosensitive material.

9. The method for manufacturing a three-dimensional structure according to claim 8, wherein the photosensitive material is curable.

10. The method for manufacturing a three-dimensional structure according to claim 1, the method comprising orienting molecules of a first anisotropic material and/or molecules of a second anisotropic material while forming a layer containing the first anisotropic material and/or the second anisotropic material and at least one resin material.

11. The method for manufacturing a three-dimensional structure according to claim 10, the method comprising orienting molecules of the first anisotropic material and/or molecules of the second anisotropic material while forming the layer using a photopolymerization initiator.

12. The method for manufacturing a three-dimensional structure according to claim 1, the method comprising orienting molecules of a first anisotropic material and/or molecules of a second anisotropic material while forming a layer containing the first anisotropic material and/or the second anisotropic material, a photosensitive material, and at least one resin material.

13. The method for manufacturing a three-dimensional structure according to claim 12, wherein the photosensitive material is curable.

14. The method for manufacturing a three-dimensional structure according to claim 12, the method comprising orienting molecules of the first anisotropic material and/or molecules of the second anisotropic material while forming the layer using a photopolymerization initiator.

15. The method for manufacturing a three-dimensional structure according to claim 1, the method further comprising curing the layer.

16. The method for manufacturing a three-dimensional structure according to claim 1, wherein the layer is formed by a stereolithography apparatus (SLA) method.

17. The method for manufacturing a three-dimensional structure according to claim 1, wherein the layer is formed by an inkjet method.

18. The method for manufacturing a three-dimensional structure according to claim 1, wherein the layer is formed by a projection method.

19. The method for manufacturing a three-dimensional structure according to claim 1, the method further comprising irradiating different regions in the layer with energy rays having different polarization directions.

20. A three-dimensional structure obtained by the manufacturing method according to claim 19 and having a molecular orientation distribution in at least one of the layers.

21. A three-dimensional structure obtained by the manufacturing method according to claim 19 and having an unoriented region in at least one of the layers.

22. The three-dimensional structure according to claim 21, comprising a region having refractive index anisotropy.

23. A three-dimensional structure obtained by the manufacturing method according to claim 1 and transparent to an electromagnetic wave in any wavelength band.
